(19) United States
(12) Patent Application Publication
(10) Pub. No.: US 2012/0188768 A1
(43) Pub. Date: Jul. 26, 2012

(54) FIRE RESCUE LASER LIGHT APPARATUS

(76) Inventors: Richard Redpath, Cary, NC (US); James Redpath, Cary, NC (US)

(21) Appl. No.: 13/013,427

(22) Filed: Jan. 25, 2011

(51) Int. Cl. G02B 27/20

(52) U.S. Cl. 362/259

(57) ABSTRACT

Disclosed is a laser light system for fire rescue. The system provides a means for a fireman to navigate a room, corridor, fire escape route, other enclosed infrastructure using laser light as a technique to penetrate smoke/fire and darkness to see doorways and object structures.

### BACKGROUND OF INVENTION

Smoke area lighting is difficult for fire rescue as well as engulfed areas for fire. Coherent light (lasers) can penetrate smoke areas without the blinding reflection of commonly used light sources as well as providing a distinguished source of lighting. A laser beam by itself cannot assist in fire rescue and so a new technique is employed of the use of a diffraction grating to produce multiple beams of light that can penetrate smoke areas.

Prior art of the use of light striping vision systems have existed since the 1980s to light stripe an object to sees its 3D dimensional form for robots to use vision algorithms to coordinate and navigate lifting objects. These light systems use lasers for coherent light. The laser system has never been envisioned for fire rescue navigation nor directly controlled by a human.

In this respect, the Fire Rescue Laser Light Apparatus substantially departs from the conventional design of robot light striping techniques used for robot object visualization system prior art and in doing so provides an improved fire escape apparatus providing depth perception and forward visibility.

### BRIEF SUMMARY OF INVENTION

The invention relates to a laser lighting apparatus for fire rescue to navigate smoke filled areas without the blinding reflection results of using conventional spatial light systems.

### BRIEF DESCRIPTION OF DRAWINGS

FIG. 1 is diagram of the embodiment operation.

FIG. 2 is diagram of the embodiment used by the observer.

FIG. 3 is a diagram of the result seen by the observer of the system.

### DETAIL DESCRIPTION OF THE INVENTION

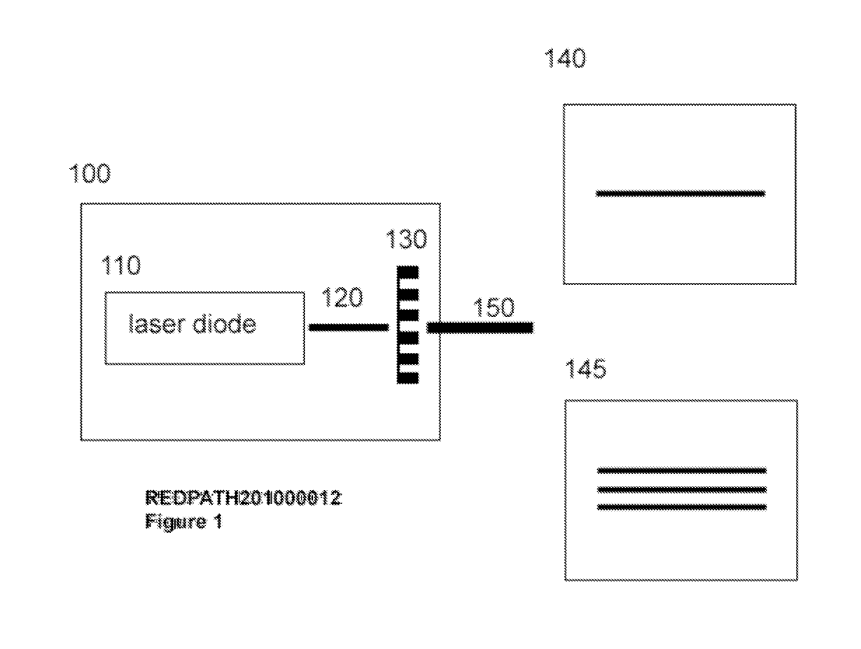

Referring to FIG. 1 at 100 is the embodiment which is constructed of a laser diode at 110 producing a beam at 120 to be incident with diffraction grating at 130. One skilled in the art of creating enclosures for lighting can be referenced to apply an enclosure for the embodiment as a product. At 140 is a cross section of the output beam at 150 from the diffraction grating at 130. The diffraction grating at 130 produces a laser line. The diffraction grating at 130 can be replaced with a multiline grating to produce more lines. For completeness at 145 is a cross section of the output beam at 150 from a multiline diffraction grating at 130 which produces three lines. It has been discovered that the number of lines should be limited as the walking of the observer could be disoriented with too much shaking information. The laser diode at 110 produces a green (532 nm) or blue (445-475 nm) light as it will contrast with fire lit areas to distinguish the light source. Scotopic vision (eye under low light condition) is stronger for blue to green light.

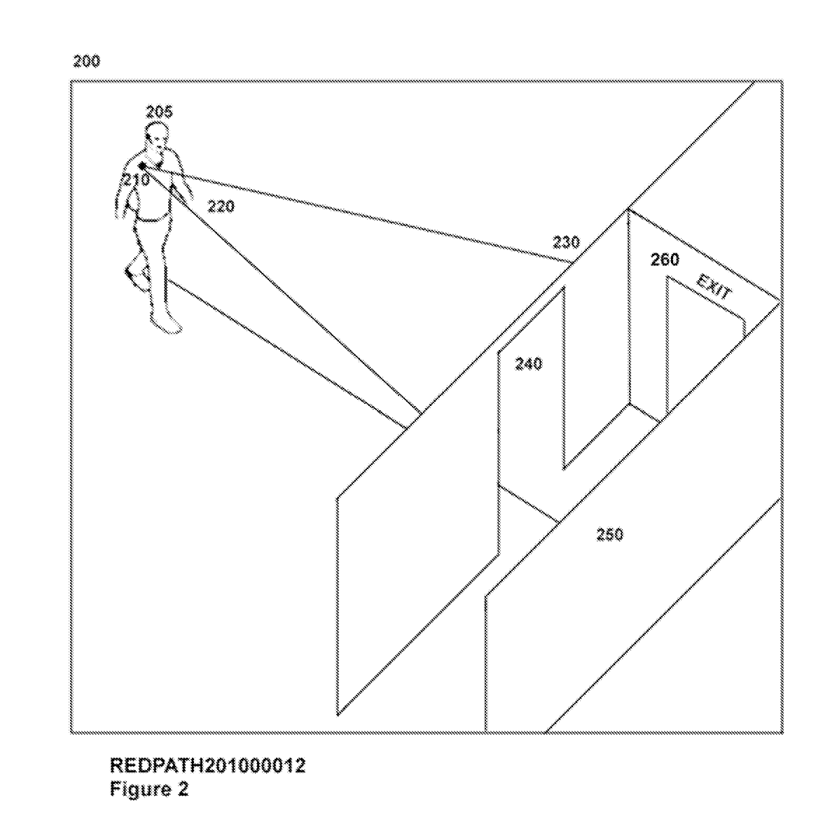

Referring to FIG. 2 at 200 is a top view drawing for a room. At 205 is an observer which has the embodiment mounted at 210. At 220 is shown the line projection from the embodiment at 210. The line projection from the embodiment at 210 strikes the wall at 230. At 240 is a door frame in the wall at 230. At 210 the embodiment projection at 220 strikes the wall 250. The observer at 205 is visually queued with a broken line indicating that a doorway is present to explore for an exit shown at 260.

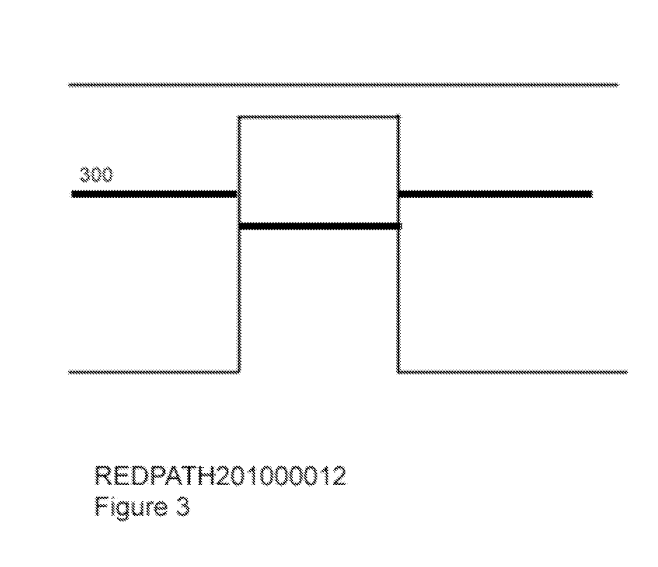

Referring to FIG. 3 at 300 is the observer's visual result of the embodiment referring to FIG. 2 at 210 for the projection 220 onto the wall at 230, doorway at 240 and wall at 250.

What is claimed is:

1. Fire Rescue Laser Light Apparatus for using coherent light in contrast color to fire navigate for rescue.

2. Fire Rescue Laser Light Apparatus in claim one using light striping to observe the 3D space of objects for rescue with human manipulation during locomotion.

3. Fire Rescue Laser Light Apparatus in claim one using a diffraction grating with alternate patterns that can be used for navigation and observation of 3D objects.
